(19) United States
(12) Patent Application Publication
(10) Pub. No.: US 2013/0260030 A1
(43) Pub. Date: Oct. 3, 2013

(54) METHOD FOR MANUFACTURING FLEXIBLE DISPLAY PANEL

(71) Applicants: Hung-yu WU, New Taipei City (TW); Jan-tian LIAN, Keelung City (TW); Chun-wei SU, New Taipei City (TW)

(72) Inventors: Hung-yu WU, New Taipei City (TW); Jan-tian LIAN, Keelung City (TW); Chun-wei SU, New Taipei City (TW)

(73) Assignee: CHUNGHWA PICTURE TUBES, LTD., Bade City (TW)

(21) Appl. No.: 13/473,639

(22) Filed: May 17, 2012

(30) Foreign Application Priority Data
Mar. 30, 2012 (TW) 101111483

(51) Int. Cl. B05D 5/10

(52) U.S. Cl. 427/207.1

(57) ABSTRACT

Disclosed is a method for manufacturing a flexible display panel. The method includes the following steps: forming a patterned thermal adhesive layer including at least one hollow area on a substrate; coating a polyimide solution; baking the patterned thermal adhesive layer and the polyimide solution, so that an adhesion force between the patterned thermal adhesive layer and the substrate is enhanced and the polyimide solution is formed into a polyimide layer; manufacturing a plurality of display elements on the polyimide layer in the hollow area for forming the flexible display panel; and cutting the flexible display panel. The present invention is capable of achieving an objective of easily separating the flexible display panel and the substrate from each other.

### TECHNICAL FIELD OF THE INVENTION

The present invention relates to a flexible display panel, and more particularly to a method for manufacturing a flexible display panel.

### BACKGROUND OF THE INVENTION

Please refer to FIGS. 1A-1F, which illustrate a method for manufacturing a flexible display panel in the prior art. In FIG. 1A, a polyimide solution 102 is coated on a glass substrate 100. In FIG. 1B, a polyimide film 104 is formed by baking the polyimide solution 102 at a high temperature. In FIG. 1C, a plurality of display areas 106 is defined on the polyimide film 104. In FIG. 1D, a plurality of display elements is manufactured in each of the display areas 106 for forming flexible display panels 108. In FIG. 1E, the flexible display panels 108 are cut. In FIG. 1F, each of the flexible display panel 108 and the glass substrate 100 thereunder are separated from each other.

In the above-mentioned processes, it is difficult to control an adhesion force between the polyimide film 104 and the glass substrate 100. When the adhesion force between the polyimide film 104 and the glass substrate 100 is too strong, it is difficult to separate the polyimide film 104 and the glass substrate 100 from each other or even the polyimide film 104 and the glass substrate 100 fail to be separated from each other. When the adhesion force between the polyimide film 104 and the glass substrate 100 is too weak, the polyimide film 104 bends or falls off easily and thus the quality of the flexible display panels 108 is affected or the manufacture of the flexible display panels 108 fails to be accomplished.

Currently, equipment for separating the polyimide film 104 and the glass substrate 100 from each other is expensive, and the manufacture steps are complicated, so that the cost of manufacturing the flexible display panels 108 is increased.

Therefore, there is a need for a solution to the above-mentioned problem that the adhesion force affects the separation of the flexible display panels and the glass substrate.

### SUMMARY OF THE INVENTION

An objective of the present invention is to provide a method for manufacturing a flexible display panel, which is capable of easily separating the flexible display panel and a substrate supporting the flexible display panel from each other.

To achieve the above-mentioned objective, a method for manufacturing a flexible display panel according to an aspect of the present invention comprises the following steps: forming a patterned thermal adhesive layer on a substrate, the patterned thermal adhesive layer comprising at least one hollow area for exposing the substrate; coating a polyimide solution on the patterned thermal adhesive layer and the hollow area; baking the patterned thermal adhesive layer and the polyimide solution for enhancing an adhesion force between the patterned thermal adhesive layer and the substrate and forming a polyimide film; manufacturing a plurality of display elements on the polyimide film in the hollow area for forming the flexible display panel; and cutting the flexible display panel.

To achieve the above-mentioned objective, a method for manufacturing a flexible display panel according to another aspect of the present invention comprises the following steps: forming a light curing adhesive layer on a substrate; coating a polyimide solution on the light curing adhesive layer; defining at least one display area on the polyimide solution by a photomask; irradiating an area excluding the display area with a light having a specific wavelength, so that the polyimide solution in the area excluding the display area sticks to the substrate through the light curing adhesive layer; forming a polyimide film by baking the polyimide solution; manufacturing a plurality of display elements on the polyimide film in the display area for forming the flexible display panel; and cutting the flexible display panel.

To achieve the above-mentioned objective, a method for manufacturing a flexible display panel according to another aspect of the present invention comprises the following steps: coating a polyimide solution on a substrate, a plurality of photoreactive monomers being mixed in the polyimide solution; forming a polyimide film by baking the polyimide solution; defining at least one display area on the polyimide film with a photomask; irradiating an area excluding the display area with a light having a specific wavelength for enhancing an adhesion force between the polyimide film in the area excluding the display area and the substrate; manufacturing a plurality of display elements on the polyimide film in the display area for forming the flexible display panel; and cutting the flexible display panel.

To achieve the above-mentioned objective, a method for manufacturing a flexible display panel according to another aspect of the present invention comprises the following steps: coating a polyimide solution on a substrate, a plurality of photoreactive monomers being mixed in the polyimide solution; forming a polyimide film by baking the polyimide solution; defining at least one display area on the polyimide film with a photomask; irradiating the display area with a light having a specific wavelength for weakening an adhesion force between the polyimide film in the display area and the substrate; manufacturing a plurality of display elements on the polyimide film in the display area for forming the flexible display panel; and cutting the flexible display panel.

By weakening an adhesion force between the flexible display panel and the substrate or enhancing an adhesion force between an area excluding the flexible display panel and the substrate, the method for manufacturing the flexible display panel of the present invention accomplishes the objective of easily separating the flexible display panel and the substrate from each other.

### BRIEF DESCRIPTION OF THE DRAWINGS

FIGS. 1A-1F illustrate a method for manufacturing a flexible display panel in the prior art;

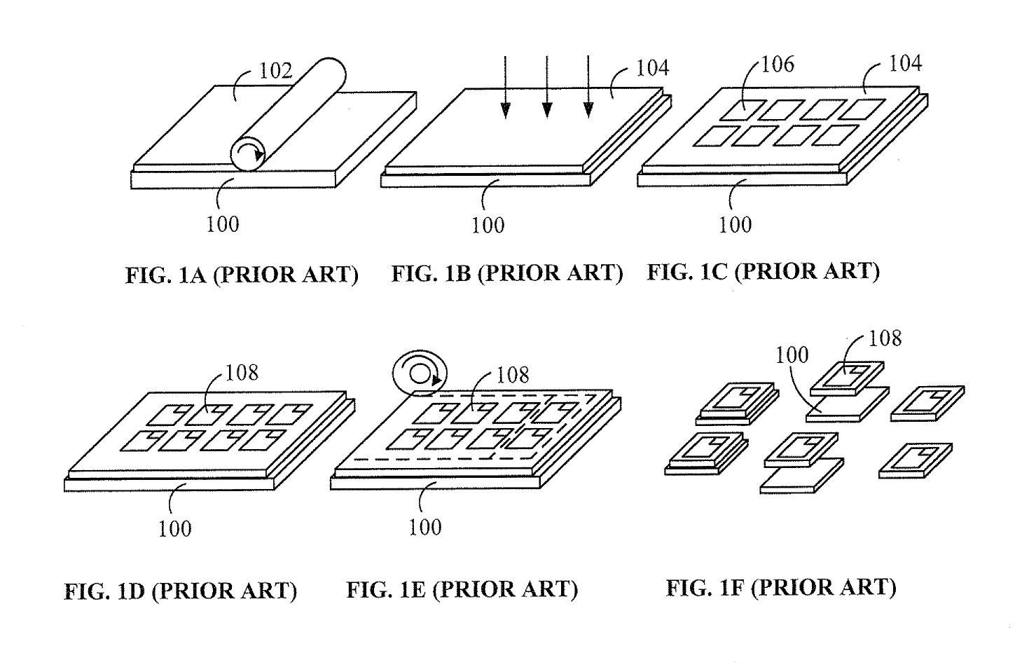

FIGS. 2A-2D illustrate a method for manufacturing a flexible display panel according to a first embodiment of the present invention;

FIGS. 3A-3E illustrate a method for manufacturing a flexible display panel according to a second embodiment of the present invention;

FIGS. 4A-4D illustrate a method for manufacturing a flexible display panel according to a third embodiment of the present invention; and

FIGS. 5A-5E illustrate a method for manufacturing a flexible display panel according to a fourth embodiment of the present invention.

### DETAILED DESCRIPTION OF THE INVENTION

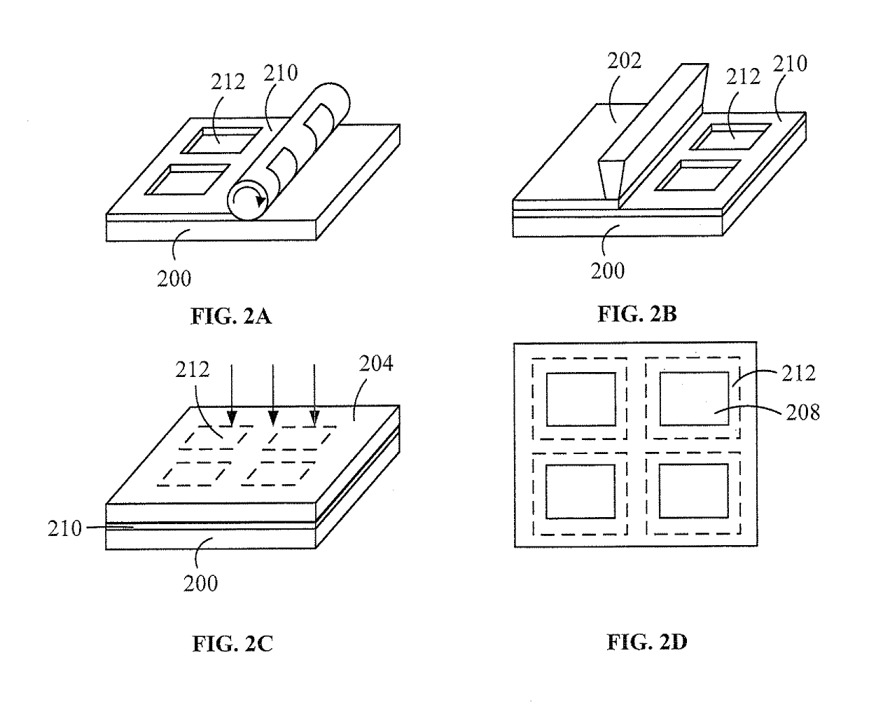

Please refer to FIGS. 2A-2D, which illustrate a method for manufacturing a flexible display panel according to a first embodiment of the present invention.

In FIG. 2A, a patterned thermal adhesive layer 210 is formed on a substrate 200. The patterned thermal adhesive layer 210 comprises at least one hollow area 212 for exposing the substrate 200. Then, the patterned thermal adhesive layer 210 is dried. For example, the patterned thermal adhesive layer 210 is dried by baking within a temperature range from 60° C. to 180° C. (usually called soft baking) or is dried naturally, thereby preventing the patterned thermal adhesive layer 210 from being mixed with a polyimide solution which will be formed thereon in the following process. The substrate 200 is usually a glass substrate. A method of forming the patterned thermal adhesive layer 210 may be an APR (Asahi Kasei Photosensitive Resin) coating which is developed by Asahi Kasei Chemicals Corporation or a screen coating.

In FIG. 2B, a polyimide solution 202 is coated on the patterned thermal adhesive layer 210 and the hollow area 212. A method of coating the polyimide solution 202 may be a spin coating or a slit coating.

In one embodiment, the step of drying the polyimide solution 202 can be implemented after the step of coating the polyimide solution 202. For example, the polyimide solution 202 is dried by baking within a temperature range from 60° C. to 180° C. (this step is usually called a soft baking) or is dried naturally. The step of drying the polyimide solution 202 may be implemented optionally depending on the type of the polyimide solution 202.

In FIG. 2C, the patterned thermal adhesive layer 210 and the polyimide solution 202 (in FIG. 2B) coated on the patterned thermal adhesive layer 210 are baked within a temperature range from 120° C. to 250° C. (this step is usually called a hard baking), so that the patterned thermal adhesive layer 210 is completely cured for enhancing an adhesion force between the patterned thermal adhesive layer 210 and the substrate 200. A polyimide film 204 is formed after the polyimide solution 202 (in FIG. 2B) is baked. Thin films are deposited on the polyimide film 204 in the hollow area 212 for manufacturing a plurality of display elements (not shown), e.g. thin film transistors, thereby forming a flexible display panel 208 as shown in FIG. 2D.

In FIG. 2D, the flexible display panel 208 in the hollow area 212 is cut. Since the patterned thermal adhesive layer 210 in FIG. 2A is not formed in the hollow area 212, an adhesion force between the flexible display panel 208 and the substrate 200 is weak. The patterned thermal adhesive layer 210 in FIG. 2A is formed on the area excluding the hollow area 212, so the adhesion force between the patterned thermal adhesive layer 210 in FIG. 2A and the substrate 200 is strong. Accordingly, the flexible display panel 208 and the substrate 200 can be separated from each other easily.

In the present embodiment, the patterned thermal adhesive layer 210 may be an epoxy resin or a ceramic adhesive.

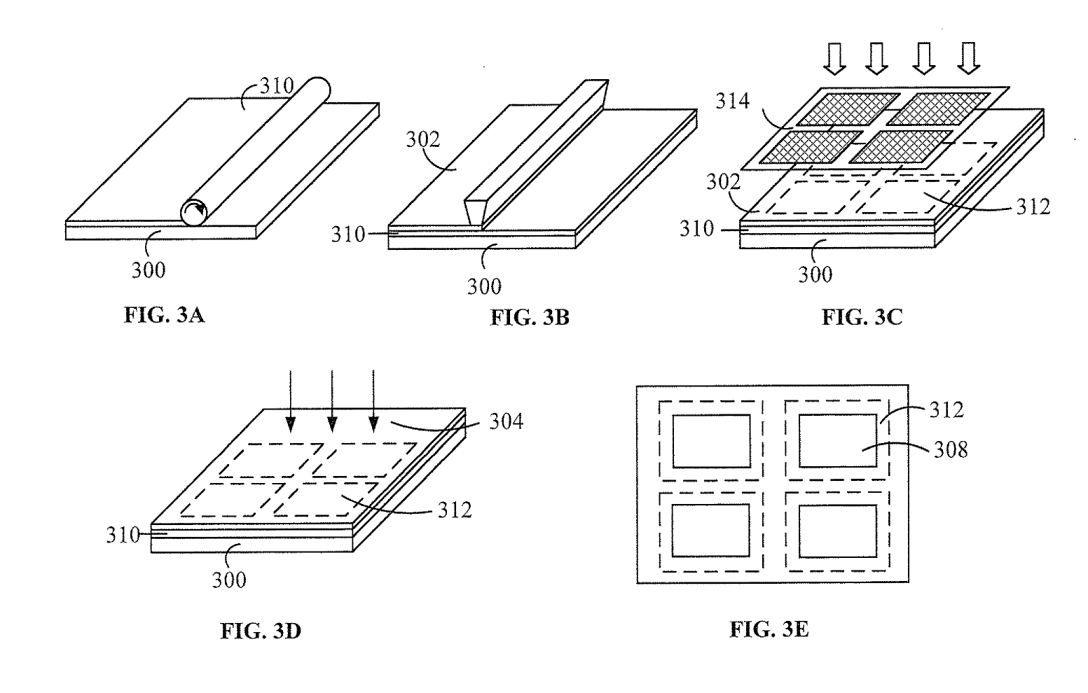

Please refer to FIGS. 3A-3E, which illustrate a method for manufacturing a flexible display panel according to a second embodiment of the present invention.

In FIG. 3A, a light curing adhesive layer 310 is formed on a substrate 300. Then, the light curing adhesive layer 310 is dried. For example, the light curing adhesive layer 310 is dried by baking within a temperature range from 60° C. to 180° C. or is dried naturally, thereby preventing the light curing adhesive layer 310 from being mixed with a polyimide solution which will be formed thereon in the following process. The substrate 300 is usually a glass substrate. A method of forming the light curing adhesive layer 310 may be an APR coating or a screen coating.

In FIG. 3B, a polyimide solution 302 is coated on the light curing adhesive layer 310. A method of coating the polyimide solution 302 may be a spin coating or a slit coating.

In one embodiment, the step of drying the polyimide solution 302 can be implemented after the step of coating the polyimide solution 302. For example, the polyimide solution 302 is dried by baking within a temperature range from 60° C. to 180° C. (this step is usually called a soft baking) or is dried naturally. The step of drying the polyimide solution 302 may be implemented optionally depending on the type of the polyimide solution 302.

In FIG. 3C, at least one display area 312 is defined on the polyimide solution 302 with a photomask 314. In the present embodiment, the display area 312 is masked by the photomask 314. After being irradiated by an ultraviolet light, the polyimide solution 302 in an area excluding the display area 312 sticks to the substrate 300 through the light curing adhesive layer 310. That is, the adhesion force between the light curing, adhesive layer 310 in the area excluding the display area 312 (which is irradiated by the ultraviolet light) and the substrate 300 is stronger than the adhesion force between the light curing adhesive layer 310 in the display area 312 (which is not irradiated by the ultraviolet light) and the substrate 300.

In FIG. 3D, the light curing adhesive layer 310 and the polyimide solution 302 (in FIG. 3C) coated on the light curing adhesive layer 310 are baked within a temperature range from 120° C. to 250° C., so that the light curing adhesive layer 310 is completely cured for enhancing the adhesion force between the light curing adhesive layer 310 and the substrate 300. A polyimide film 304 is formed after the polyimide solution (in FIG. 3C) is baked. Thin films are deposited on the polyimide film 304 in the display area 312 for manufacturing a plurality of display elements (not shown), e.g. thin film transistors, thereby forming a flexible display panel 308 as shown in FIG. 3D.

In FIG. 3E, the flexible display panel 308 in the display area 312 is cut. Since the adhesion force between the light curing adhesive layer 310 in the display area 312 in FIG. 3D and the substrate 300 is weaker than the adhesion force between the light curing adhesive layer 310 in the area excluding the display area 312 in FIG. 3D and the substrate 300, the flexible display panel 308 and the substrate 300 can be separated from each other easily after the cutting process.

In the present embodiment, the light curing adhesive layer 310 may be an ultraviolet (UV) light curing adhesive.

Because the light curing adhesive layer 310 is formed on the whole surface of the substrate 300 (i.e. the light curing adhesive layer 310 is not patterned), the polyimide film 304 is flatter than the polyimide film 204 of the first embodiment.

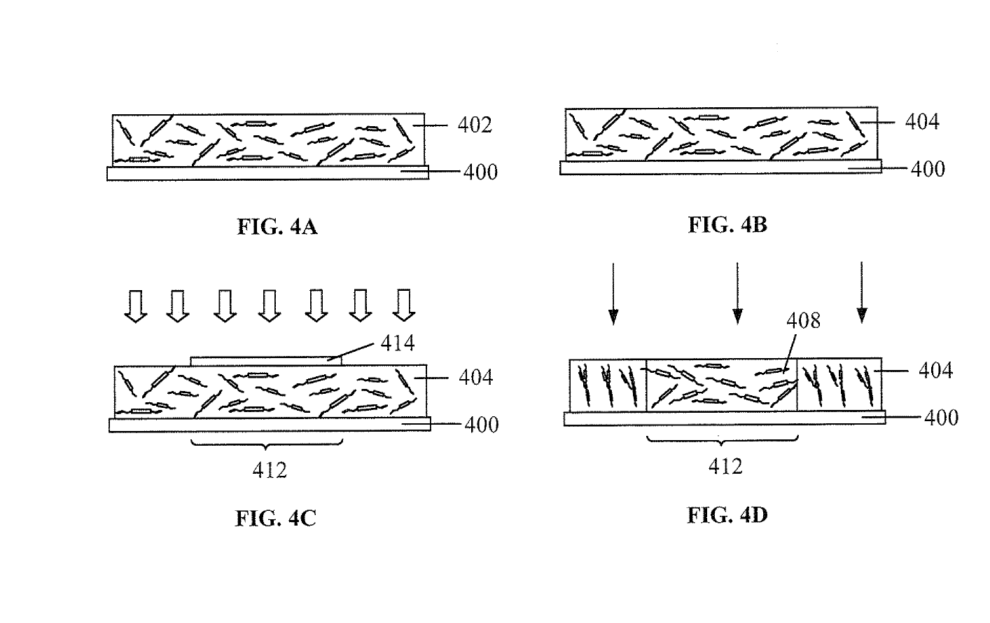

Please refer to FIGS. 4A-4D, which illustrate a method for manufacturing a flexible display panel according to a third embodiment of the present invention.

In FIG. 4A, a polyimide solution 402 is coated on a substrate 400. A plurality of photoreactive monomers is mixed in the polyimide solution 402. The photoreactive monomers are molecules which may bind chemically to other molecules to form polymers after they are irradiated by a light having a specific wavelength. A method of coating the polyimide solution 402 may be a spin coating or a slit coating.

The substrate 400 is usually a glass substrate. The glass substrate is hydrophilic. The glass substrate easily loses the characteristic of hydrophile due to contamination in the atmosphere. The characteristic of hydrophile may be recovered by washing the glass substrate with an ultraviolet light, ozone, or oxygen plasma. In contrast, the glass substrate may be changed to have the characteristic of hydrophobic by film plating techniques. The photoreactive monomers can make the glass substrate and a polyimide film which will be formed in the following process have the same characteristic, thereby enhancing an adhesion force between the glass substrate and the polyimide film after being irradiated.

In FIG. 4B, a polyimide film 404 is formed by baking the polyimide solution 402 in FIG. 4A within a temperature range from 60° C. to 180° C. The adhesion force between the polyimide film 404 which is formed by baking the polyimide solution 402 and the substrate 400 is not changed.

In FIG. 4C, at least one display area 412 is defined on the polyimide film 404 by a photomask 414. In the present embodiment, the display area 412 is masked by the photomask 414. After an ultraviolet light irradiates the polyimide film 404, one end of each of the photoreactive monomers in the area excluding the display area 412 binds with polyimide molecules of the polyimide film 404, while the other end of each of the photoreactive monomers in the area excluding the display area 412 binds with the substrate 400. As a result, the adhesion force between the polyimide film 404 in the area excluding the display area 412 and the substrate 400 is enhanced. Preferredly, the ultraviolet light has a wavelength ranging from 200 nanometers (nm) to 400 nm.

In FIG. 4D, a plurality of display elements (not shown), e.g. thin film transistors, thereby forming a flexible display panel 408. Then, the polyimide film 404 is baked within a temperature range from 120° C. to 250° C., so as to further enhance the adhesion force between the polyimide molecules in the area excluding the display area 412 and the substrate 400. Finally, the flexible display panel 408 is cut. Since the adhesion force between the flexible display panel 408 and the substrate 400 is weaker than the adhesion force between the polyimide film 404 in the area excluding the display area 412 and the substrate 400, the flexible display panel 408 and the substrate 400 can be separated from each other easily after the cutting process.

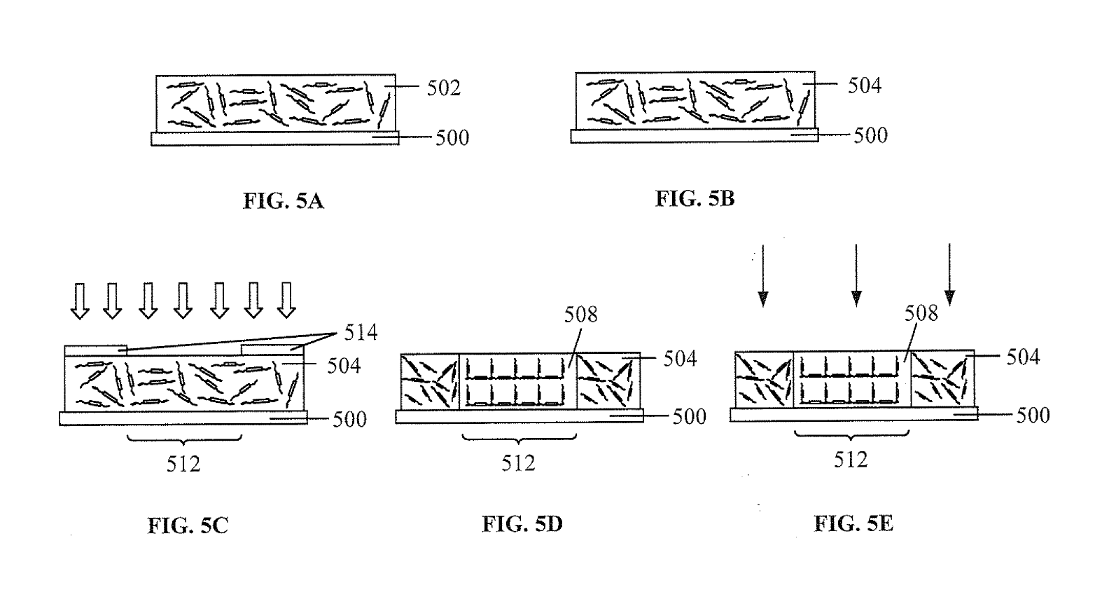

Please refer to FIGS. 5A-5E, which illustrate a method for manufacturing a flexible display panel according to a fourth embodiment of the present invention.

In FIG. 5A, a polyimide solution 502 is coated on a substrate 500. A plurality of photoreactive monomers is mixed in the polyimide solution 502. A method of coating the polyimide solution 502 may be a spin coating or a slit coating.

The substrate 500 is usually a glass substrate. The glass substrate is hydrophilic. The glass substrate easily loses the characteristic of hydrophile due to contamination in the atmosphere. The characteristic of hydrophile may be recovered by washing the glass substrate with an ultraviolet light, ozone, or oxygen plasma. In contrast, the glass substrate may be changed to have the characteristic of hydrophobic by film plating techniques. The photoreactive monomers can weaken the adhesion force between the glass substrate and a polyimide film which will be formed in the following process after being irradiated.

In FIG. 5B, a polyimide film 504 is formed by baking the polyimide solution 502 in FIG. 5A within a temperature range from 60° C. to 180° C. The adhesion force between the polyimide film 504 which is formed by baking the polyimide solution 502 and the substrate 500 is not changed.

In FIG. 5C, at least one display area 512 is defined on the polyimide film 504 by a photomask 514. In the present embodiment, the display area 512 is not masked by the photomask 514. After an ultraviolet light irradiates the polyimide film 504 in the display area 512, the photoreactive monomers in the display area 512 bind with polyimide molecules of the polyimide film 504, thereby weakening the adhesion force between the polyimide molecules in the display area 512 and the substrate 500. The adhesion force between an area which is not irradiated by the ultraviolet light and the substrate 500 is stronger. Preferredly, the ultraviolet light has a wavelength ranging from 200 nm to 400 nm.

In FIG. 5D, a plurality of display elements (not shown), e.g. thin film transistors, thereby forming a flexible display panel 508.

Then, the polyimide film 504 is baked at a temperature range from 120° C. to 250° C., so as to further enhance the adhesion force between the polyimide molecules in the area excluding the display area 512 and the substrate 500. Finally, the flexible display panel 508 is cut. Since the adhesion force between the flexible display panel 508 and the substrate 500 is weaker than the adhesion force between the polyimide film 504 in the area excluding the display area 512 and the substrate 500, the flexible display panel 508 and the substrate 500 can be separated from each other easily after the cutting process.

In summary, the objective of easily separating the flexible display panel and the substrate from each other in the first and second embodiments is accomplished by utilizing the adhesives for making the adhesion forces in the display area and the non-display area different; the objective of easily separating the flexible display panel and the substrate from each other in the third and fourth embodiments is accomplished by mixing the photoreactive monomers in the polyimide solution and then changing the adhesion force by irradiating the ultraviolet light.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for manufacturing a flexible display panel, comprising the following steps:
forming a patterned thermal adhesive layer on a substrate, the patterned thermal adhesive layer comprising at least one hollow area for exposing the substrate;
coating a polyimide solution on the patterned thermal adhesive layer and the hollow area;
baking the patterned thermal adhesive layer and the polyimide solution for enhancing an adhesion force between the patterned thermal adhesive layer and the substrate and forming a polyimide film;
manufacturing a plurality of display elements on the polyimide film in the hollow area for forming the flexible display panel; and
cutting the flexible display panel.

2. The method for manufacturing the flexible display panel of claim 1, further comprising the step of drying the patterned thermal adhesive layer after the step of forming the patterned thermal adhesive layer.

3. The method for manufacturing the flexible display panel of claim 2, wherein the step of drying the patterned thermal adhesive layer is implemented by baking the thermal patterned thermal adhesive layer within a temperature range from 60° C. to 180° C.

4. The method for manufacturing the flexible display panel of claim 1, further comprising the step of drying the polyimide solution after the step of coating the polyimide solution.

5. The method for manufacturing the flexible display panel of claim 4, wherein the step of drying the polyimide solution is implemented by baking the polyimide solution within a temperature range from 60° C. to 180° C.

6. The method for manufacturing the flexible display panel of claim 1, wherein the step of baking the patterned thermal adhesive layer and the polyimide solution is implemented within a temperature range from 120° C. to 250° C.

7. A method for manufacturing a flexible display panel, comprising the following steps:
forming a light curing adhesive layer on a substrate;
coating a polyimide solution on the light curing adhesive layer;
defining at least one display area on the polyimide solution by a photomask;
irradiating an area excluding the display area with a light having a specific wavelength, so that the polyimide solution in the area excluding the display area sticks to the substrate through the light curing adhesive layer;
forming a polyimide film by baking the polyimide solution;
manufacturing a plurality of display elements on the polyimide film in the display area for forming the flexible display panel; and
cutting the flexible display panel.

8. The method for manufacturing the flexible display panel of claim 7, further comprising the step of drying the light curing adhesive layer after the step of forming the light curing adhesive layer.

9. The method for manufacturing the flexible display panel of claim 8, wherein the step of drying the light curing adhesive layer is implemented by baking the light curing adhesive layer within a temperature range from 60° C. to 180° C.

10. The method for manufacturing the flexible display panel of claim 7, further comprising the step of drying the polyimide solution after the step of coating the polyimide solution.

11. The method for manufacturing the flexible display panel of claim 10, wherein the step of drying the polyimide solution is implemented by baking the polyimide solution within a temperature range from 60° C. to 180° C.

12. The method for manufacturing the flexible display panel of claim 7, wherein the step of baking the polyimide solution is implemented within a temperature range from 120° C. to 250° C.

13. The method for manufacturing the flexible display panel of claim 7, wherein the light having the specific wavelength is an ultraviolet light.

14. A method for manufacturing a flexible display panel, comprising the following steps:
coating a polyimide solution on a substrate, a plurality of photoreactive monomers being mixed in the polyimide solution;
forming a polyimide film by baking the polyimide solution;
defining at least one display area on the polyimide film with a photomask;
irradiating an area excluding the display area with a light having a specific wavelength for enhancing an adhesion force between the polyimide film in the area excluding the display area and the substrate;
manufacturing a plurality of display elements on the polyimide film in the display area for forming the flexible display panel; and
cutting the flexible display panel.

15. The method for manufacturing the flexible display panel of claim 14, wherein the step of baking the polyimide solution is implemented within a temperature range from 60° C. to 180° C.

16. The method for manufacturing the flexible display panel of claim 14, wherein the light has the specific wavelength ranging from 200 nanometers to 400 nanometers.

17. A method for manufacturing a flexible display panel, comprising the following steps:
coating a polyimide solution on a substrate, a plurality of photoreactive monomers being mixed in the polyimide solution;
forming a polyimide film by baking the polyimide solution;
defining at least one display area on the polyimide film with a photomask;
irradiating the display area with a light having a specific wavelength for weakening an adhesion force between the polyimide film in the display area and the substrate;
manufacturing a plurality of display elements on the polyimide film in the display area for forming the flexible display panel; and
cutting the flexible display panel.

18. The method for manufacturing the flexible display panel of claim 17, wherein the step of baking the polyimide solution is implemented within a temperature range from, 60° C. to 180° C.

19. The method for manufacturing the flexible display panel of claim 17, wherein the light has the specific wavelength ranging from 200 nanometers to 400 nanometers.
